(19) United States
(12) Patent Application Publication
(10) Pub. No.: US 2013/0208013 A1
(43) Pub. Date: Aug. 15, 2013

(54) APPARATUS AND METHOD FOR MANAGING OBJECT IN PORTABLE ELECTRONIC DEVICE

(71) Applicant: SAMSUNG ELECTRONICS CO. LTD., (US)

(72) Inventors: Beyong-Ho YUU, Seoul (KR); Young-Ho KIM, Hwaseong-si (KR); Kyu-Hyuk LEE, Seongnam-si (KR); Tae-Sung CHOI, Seoul (KR)

(73) Assignee: SAMSUNG ELECTRONICS CO. LTD., Suwon-si (KR)

(21) Appl. No.: 13/767,225

(22) Filed: Feb. 14, 2013

(30) Foreign Application Priority Data
Feb. 15, 2012 (KR) 10-2012-0015399

(51) Int. Cl. G06T 3/40

(52) U.S. Cl. CPC G06T 3/40
USPC 345/661

(57) ABSTRACT

An apparatus and a method for displaying an object in a portable electronic device are provided. The method for displaying the object includes displaying at least one object according to a first arrangement, and when an object size change event occurs, changing a size of the at least one object and displaying the at least one object having the changed size by changing an object arrangement to a second arrangement.

### PRIORITY

This application claims the benefit under 35 U.S.C. §119(a) of a Korean patent application filed on Feb. 15, 2012, in the Korean Intellectual Property Office and assigned Serial No. 10-2012-0015399, the entire disclosure of which is hereby incorporated by reference.

### BACKGROUND OF THE INVENTION

1. Field of the Invention

The present invention relates generally to a portable electronic device. More particularly, the present invention relates to an apparatus and a method for managing an object such as, for example, an application program icon, a widget, a thumbnail image, and the like, in the portable electronic device.

2. Description of the Related Art

Portable electronic devices, which are easily portable and which have become necessities in modern life, are advancing and being developed into multimedia devices which provide various services such as voice and video communication functions, information input/output function, data storage, and the like.

As use of multimedia services using portable electronic devices increases, a demand for information having improved quality to be processed and displayed by the portable electronic device also increases. Hence, there is a corresponding increase in demand for a portable electronic device including a touch screen which can enlarge a display by improving use of space.

To efficiently manage an image file stored in a storage, the portable electronic device can display a thumbnail of the corresponding image file. Herein, the image file corresponds to a photo file and a video file.

Because the size of the display is limited for the sake of the portability, the portable electronic device displays a small thumbnail of the image file. As a result, a user of the portable electronic device cannot accurately perceive the thumbnail.

To address this shortcoming, the portable electronic device requires a user interface allowing the user to easily perceive and manage an object such as thumbnail.

Therefore, a need exists for an apparatus, system and method for providing a user interface for user's object identification in a portable electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address the above-mentioned problems and/or disadvantages and to provide at least the advantages described below. Accordingly, an aspect of the present invention to provide an apparatus and a method for providing a user interface for user's object identification in a portable electronic device.

Another aspect of the present invention is to provide an apparatus and a method for providing a user interface for user's object identification in a portable electronic device including a touch screen.

Another aspect of the present invention is to provide an apparatus and a method for managing a size and a display arrangement of an object for user's object identification in a portable electronic device.

Another aspect of the present invention is to provide an apparatus and a method for controlling a plurality of objects at the same time in a portable electronic device.

Another aspect of the present invention is to provide an apparatus and a method for changing a display arrangement of objects when a size of the objects is changed in a portable electronic device.

According to an aspect of the present invention, a method for displaying an object in a portable electronic device is provided. The method includes displaying at least one object according to a first arrangement, and when an object size change event occurs, changing a size of the at least one object and displaying the at least one object having the changed size according to a second arrangement.

According to another aspect of the present invention, a portable electronic device is provided. The device includes a means for displaying at least one object in a display according to a first arrangement, and when an object size change event occurs, a means for changing a size of the at least one object and for displaying the at least one object having the changed size by changing an object arrangement to a second arrangement.

According to yet another aspect of the present invention, an apparatus of an electronic device is provided. The apparatus includes a display, at least one processor, a storage, and at least one program stored in the storage and configured for execution by the at least one processor. The program includes instructions for displaying at least one object in the display according to a first arrangement, and for changing a size of the at least one object in the display and for displaying the at least one object having the changed size in the display according to a second arrangement when an object size change event occurs.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable electronic device according to an exemplary embodiment of the present invention;

FIG. 2 is a flowchart of a method for changing an object size in a portable electronic device according to an exemplary embodiment of the present invention;

FIG. 3 is a flowchart of a method for changing an object size in a portable electronic device according to another exemplary embodiment of the present invention;

FIGS. 4A to 4D are diagrams of a screen configuration for changing an object size in a portable electronic device according to an exemplary embodiment of the present invention;

FIGS. 5A to 5D are diagrams of a screen configuration for changing an object size in a portable electronic device according to another exemplary embodiment of the present invention;

FIG. 6 is a flowchart of a method for changing an object size in a portable electronic device according to another exemplary embodiment of the present invention;

FIGS. 7A to 7C are diagrams of a screen configuration for changing an object size in a portable electronic device according to another exemplary embodiment of the present invention; and

FIGS. 8A to 8C are diagrams of a screen configuration for changing an object size in a portable electronic device according to another exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for managing an object in a portable electronic device. According to exemplary embodiments of the present invention, the object corresponds to an application program icon, a widget, a thumbnail image, and the like.

According to exemplary embodiments of the present invention, the portable electronic device may correspond to a mobile communication terminal, a Personal Digital Assistant (PDA), a laptop, a smart phone, a netbook, a Mobile Internet Device (MID), an Ultra Mobile Personal Computer (UMPC), a tablet PC, a navigation device, an MP3, and the like.

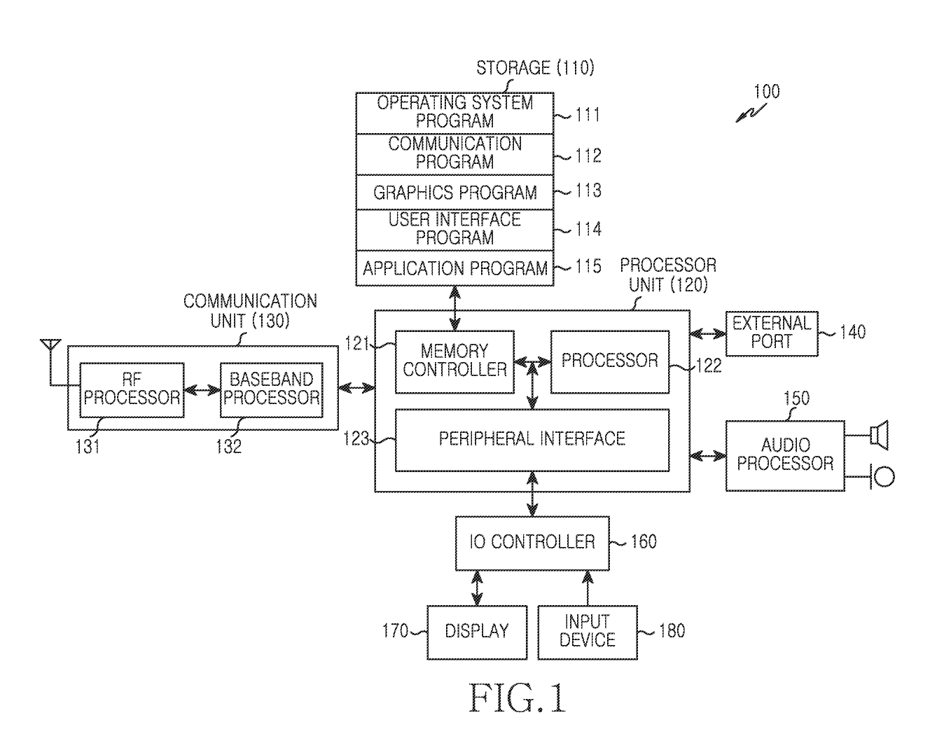

FIG. 1 is a block diagram of a portable electronic device according to an exemplary embodiment of the present invention.

Referring to FIG. 1, the portable electronic device 100 includes a storage 110, a processor unit 120, a communication unit 130, an external port 140, an audio processor 150, an Input Output (IO) controller 160, a display 170, and an input device 180. According to exemplary embodiments of the present invention, the portable electronic device may be equipped with a plurality of storages 110, a plurality of external ports 140, and/or the like.

The processor unit 120 includes a memory controller 121, a processor 122, and a peripheral interface 123. According to exemplary embodiments of the present invention, the processor unit 120 may be equipped with a plurality of processors 122.

The communication unit 130 includes a Radio Frequency (RF) processor 131 and a baseband processor 132.

According to exemplary embodiments of the present invention, various components included in the portable electronic device 100 can be implemented using hardware such as one or more integrated circuits, software, or a combination of the hardware and the software.

According to exemplary embodiments of the present invention, the storage 110 includes a program storage for storing a program to control the operations of the portable electronic device 100, and a data storage for storing data generated by the program execution. For example, the program storage may include an operating system program 111, a communication program 112, a graphics program 113, a user interface program 114, at least one application program 115, and the like.

According to exemplary embodiments of the present invention, the operating system program 111 includes at least one software component for controlling general system operations. The operating system program 111 also facilitates communication between hardware devices and the software components.

According to exemplary embodiments of the present invention, the communication program 112 includes at least one software component for processing data transmitted and received through the RF processor 131 or the external port 140.

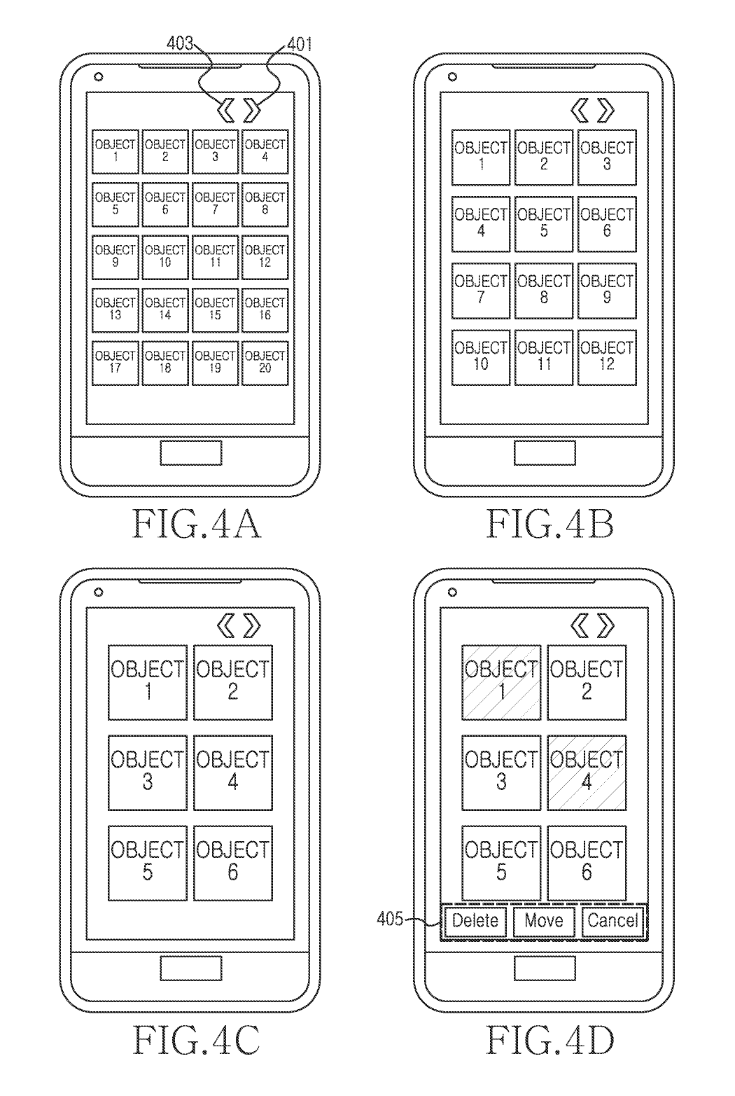

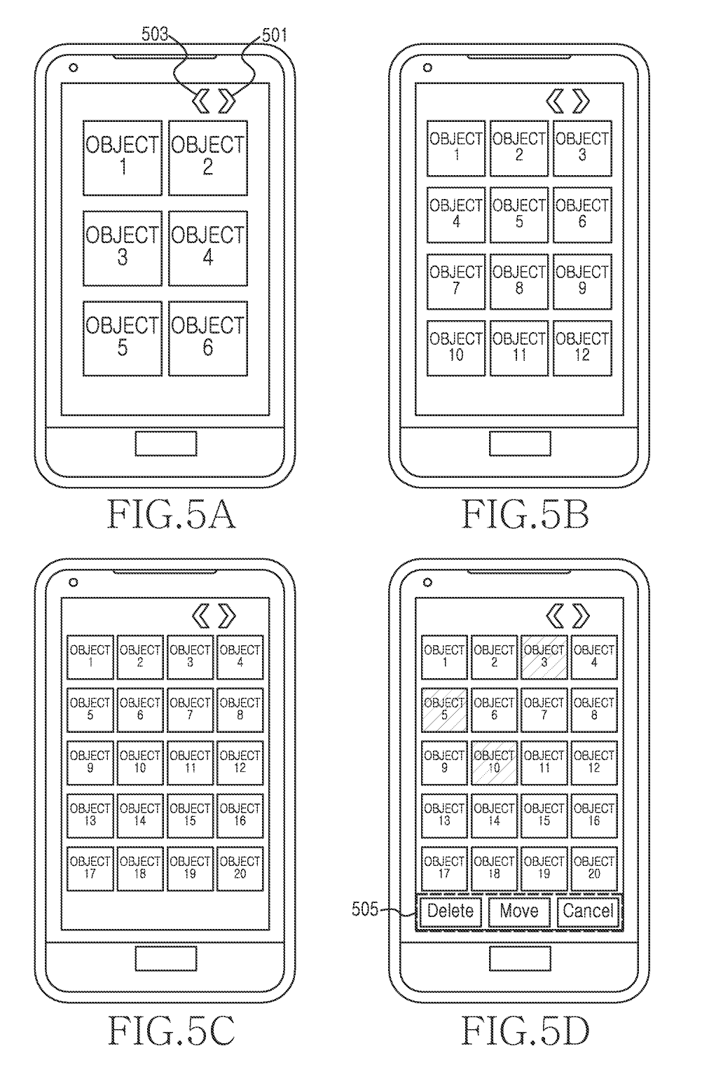

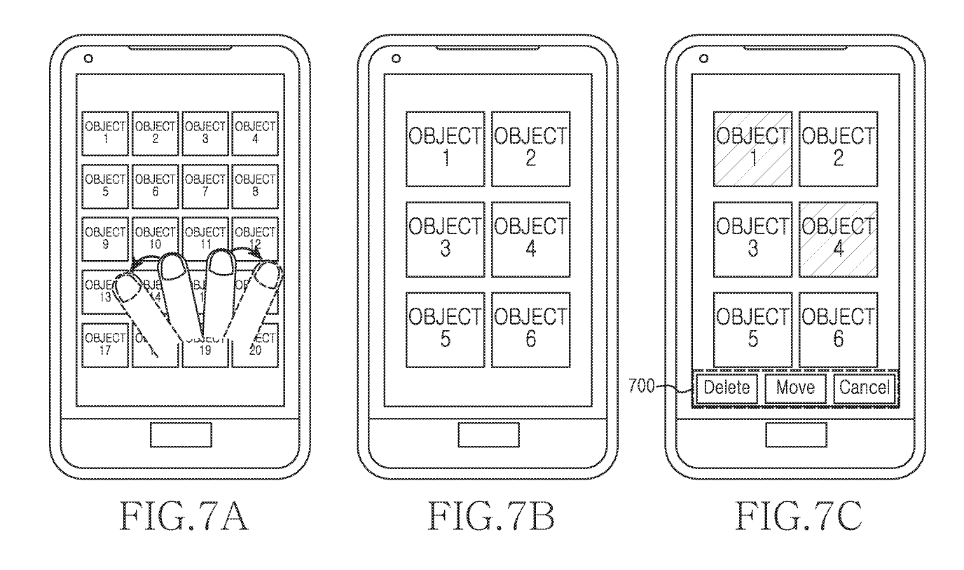

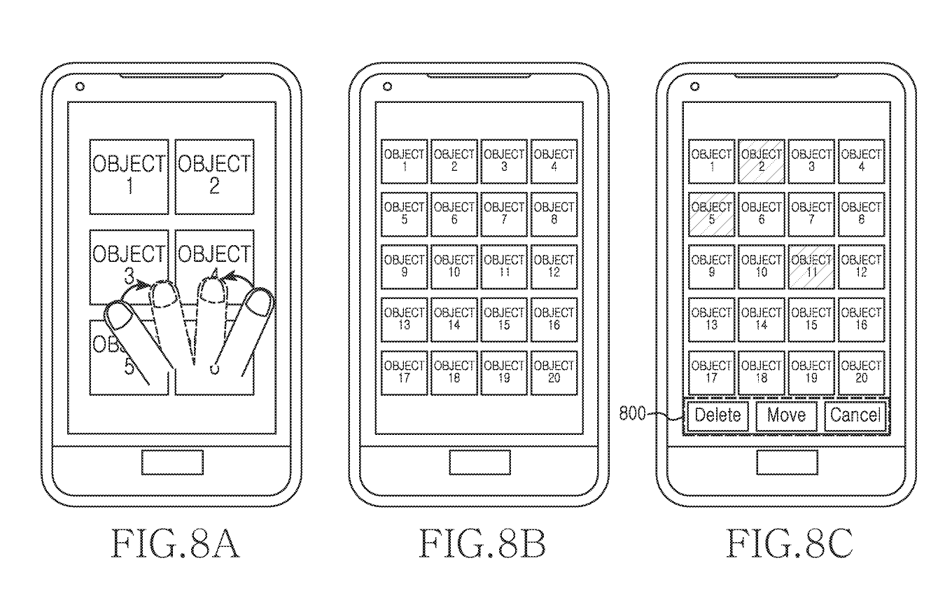

According to exemplary embodiments of the present invention, the graphics program 113 includes at least one software component for providing a graphic user interface on the display 170. For example, when an object zoom-in event is identified (or selected) through the user interface program 114, the graphics program 113 includes an instruction for changing a display arrangement of the object according to the object size enlargement as shown in FIG. 4A to 4D and/or FIGS. 7A to 7C. For example, when an object zoom-out event is identified (or selected) through the user interface program 114, the graphics program 113 includes an instruction for changing the display arrangement of the object according to the object size reduction as shown in FIG. 5 and/or FIG. 8. As an example, the object encompasses a text, a webpage, an icon, a digital image, a video, an animation, a thumbnail image, and the like.

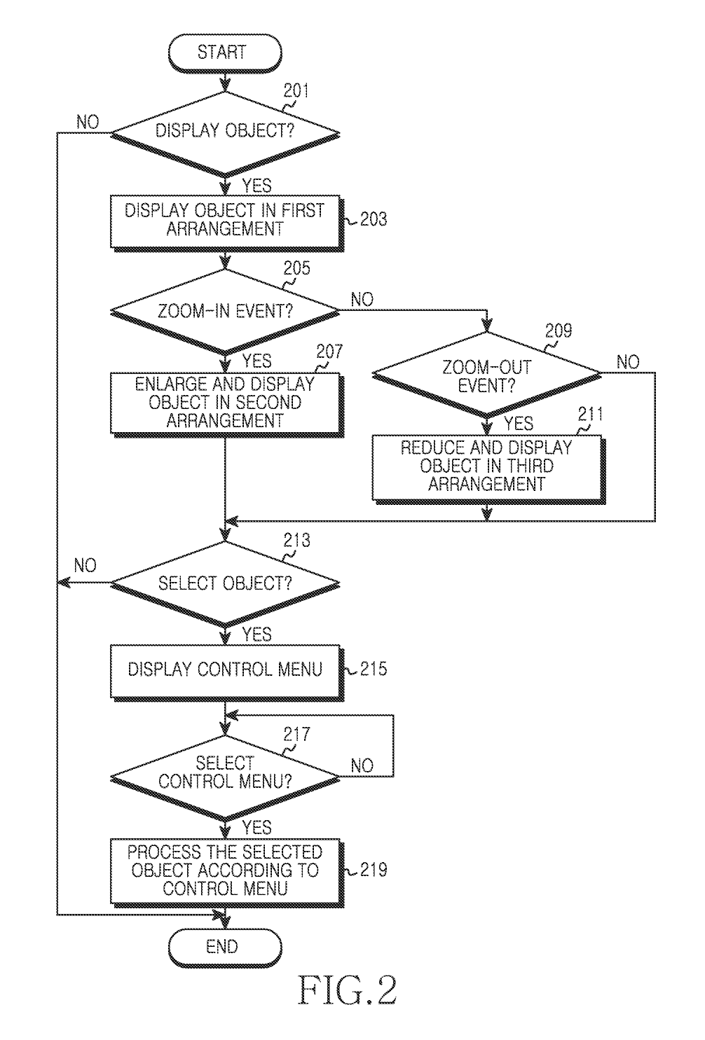

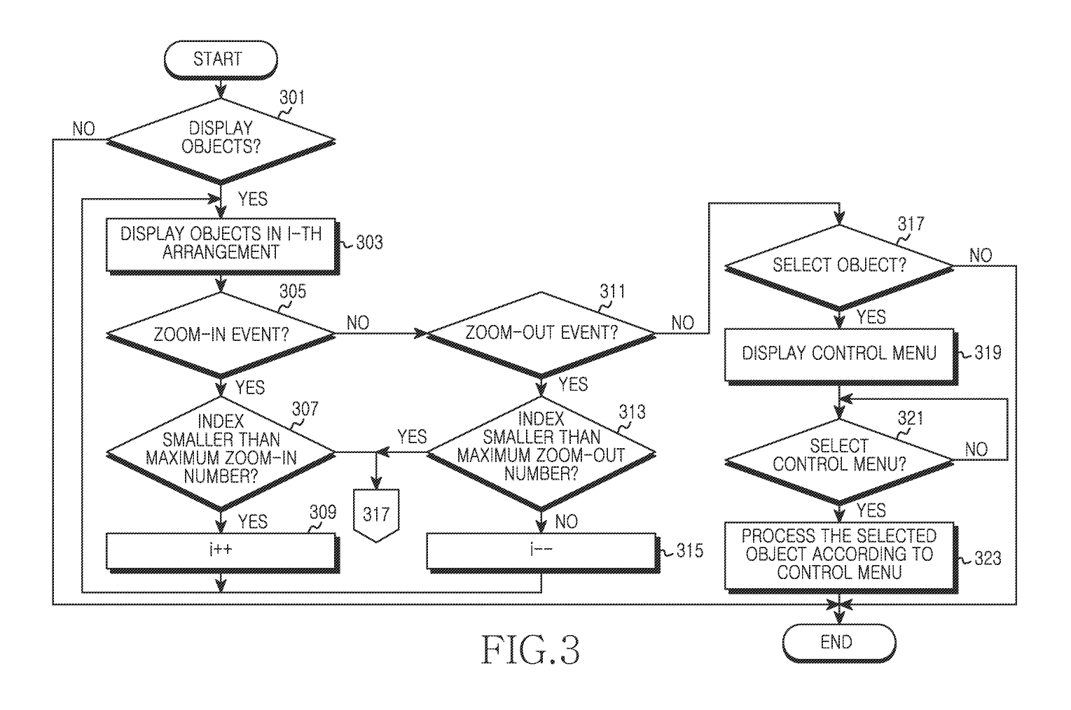

According to exemplary embodiments of the present invention, the user interface program 114 includes at least one software component relating to the user interface between the portable electronic device 100 and a user. For example, when the user of the portable electronic device 100 generates the object zoom-in event through the display 170 or the input device 180, the user interface program 114 includes an instruction which controls to enlarge the object according to a zoom-in scale of the object as shown in FIGS. 2, 3, and/or 6, and an instruction which controls to change the object display arrangement. For example, when the user of the portable electronic device 100 generates the object zoom-out event through the display 170 or the input device 180, the user interface program 114 may include an instruction which controls to reduce the object according to a zoom-out scale of the object as shown in FIGS. 2, 3, and/or 6, and to change the object display arrangement. For example, when the user of the portable electronic device 100 selects a plurality of objects through the display 170 or the input device 180, the user interface program 114 may include an instruction which controls to display a control menu. In so doing, the user interface program 114 may include an instruction which controls to process the objects selected by the user at the same time according to a control command input through the display 170 and/or the input device 180.

According to exemplary embodiments of the present invention, the application program 115 includes a software component for at least one application program installed in the portable electronic device 100.

According to exemplary embodiments of the present invention, the memory controller 121 of the processor unit 120 controls access to the storage 110 by another component such as processor 122, peripheral interface 123, and the like to the storage 110.

According to exemplary embodiments of the present invention, the peripheral interface 123 controls connection between a peripheral of the portable electronic device 100 and the processor 122, the storage 110, and the like.

According to exemplary embodiments of the present invention, the processor 122 controls to provide various services such as voice communication, data communication, and the like. The processor 122 controls to provide the multimedia service corresponding to the relevant program by executing the program stored to the storage 110. For example, the processor 122 manages the object by executing the graphics program 113 and the user interface program 114.

According to exemplary embodiments of the present invention, the memory controller 121, the processor 122, and the peripheral interface 123 of the processor unit 120 may be implemented using a single chip or a separate chip.

According to exemplary embodiments of the present invention, the RF processor 131 of the communication unit 130 processes RF signals transmitted and received over an antenna. For example, the RF processor 131 converts a baseband signal output from the baseband processor 132 to an RF signal and transmits the RF signal over the antenna. The RF processor 131 converts an RF signal output from the antenna to a baseband signal and sends the baseband signal to the baseband processor 132. As an example, the RF processor 131 may include an RF transceiver, an amplifier, a tuner, an oscillator, a digital signal processor, a COding DECoding (CODEC) chipset, a Subscriber Identity Module (SIM) card, and the like.

According to exemplary embodiments of the present invention, the external port 140 includes a connection interface for connecting the portable electronic device 100 to another device directly or over a network. For example, the external port 140 may include a Universal Serial Bus (USB) port, a Firewire port, and/or the like.

According to exemplary embodiments of the present invention, the audio processor 150 provides an audio interface between the user and the portable electronic device 100 through a speaker and a microphone.

According to exemplary embodiments of the present invention, the IO controller 160 provides an interface between the peripheral interface 123 and an IO device such as display 170, input device 180, and the like.

According to exemplary embodiments of the present invention, the display 170 displays status information of the portable electronic device 100, characters used by the user, a moving picture, a still picture, and the like under the control of the graphics program 113. When the display 170 is a touch screen, the display 170 provides input information detected through a touchpad to the processor unit 120 via the IO controller 160.

According to exemplary embodiments of the present invention, the input device 180 provides input data generated by the user's selection, to the processor unit 120 via the IO controller 160. For example, the input device 180 includes a control button for controlling the portable electronic device 100. For example, the input device 180 may include a keypad for receiving input data from the user.

FIG. 2 is a flowchart of a method for changing an object size in a portable electronic device according to one exemplary embodiment of the present invention. FIGS. 4A to 4D are diagrams of a screen configuration for changing an object size in a portable electronic device according to one exemplary embodiment of the present invention. FIGS. 5A to 5D are diagrams of a screen configuration for changing an object size in a portable electronic device according to another exemplary embodiment of the present invention.

Referring to FIGS. 2, 4A to 4D, and 5A to 5D, the portable electronic device determines whether to display at least one object in the display 170 in step 201. For example, the portable electronic device determines whether the user executes the application program to display the thumbnail image. As another example, the portable electronic device determines whether the user executes a standby mode to display the object of the application program installed in the portable electronic device.

If the portable electronic device determines that an application program to display the object is not executed, the portable electronic device ends the process.

In contrast, if the portable electronic device determines that the application program to display the object is executed, the portable electronic device proceeds to step 203.

To display the object, the portable electronic device displays at least one object in the display 170 according to a first arrangement in step 203. For example, the portable electronic device displays at least one object in the display 170 according to the first arrangement as shown in FIGS. 4A and/or 5A. As an example, the first arrangement includes a basic object display arrangement or an arrangement used to display the object in a previous object display algorithm. For example, when the previous object display algorithm enlarges objects in a 3×2 arrangement as shown in FIG. 4C, the first arrangement is set to the 3×2 arrangement.

In step 205, the portable electronic device determines whether a zoom-in event occurs. For example, the portable electronic device determines whether a zoom-in icon 401 is selected in an object display screen as shown in FIG. 4A (or zoom-in icon 501 as shown in FIG. 5A). As an example, the portable electronic device can determine whether the zoom-in event occurs based on touch information. For example, the portable electronic device may determine whether the zoom-in event generates based on a user's gesture.

When the zoom-in event occurs (or is detected), the portable electronic device changes the object display arrangement to a second arrangement and enlarges the object size in step 207. For example, when the zoom-in event occurs in the object display screen of a 5×4 arrangement of FIG. 4A, the portable electronic device changes the object display arrangement to a4×3 arrangement and enlarges the object size as shown in FIG. 4B. For example, using the 5×4 arrangement, the portable electronic device can display 20 objects in the display 170. Using the 4×3 arrangement, the portable electronic device can display 12 objects in the display 170. Hence, the portable electronic device can change the object display arrangement to the 4×3 arrangement and enlarge the object size.

In contrast, when a no zoom-in event occurs (e.g., or is detected, or in the absence of a zoom-in event), the portable electronic device determines whether the zoom-out event occurs in step 209. For example, the portable electronic device determines whether a zoom-out icon 503 is selected in the object display screen as shown in FIG. 5A (or zoom-out icon 403 as shown in FIG. 4A). As an example, the portable electronic device can determine whether the zoom-out event generates based on the touch information. For example, the portable electronic device may determine whether the zoom-out event generates based on a user's gesture.

When the zoom-out event occurs, the portable electronic device changes the object display arrangement to a third arrangement and reduces the object size in step 211. For example, when the zoom-out event takes place in the object display screen of the 3×2 arrangement of FIG. 5A, the portable electronic device changes the object display arrangement to the 4×3 arrangement and reduces the object size as shown in FIG. 5B.

In addition, after displaying the object in steps 203, 207, and 211, the portable electronic device may determine whether the object displayed in the display 170 is selected in step 213. As an example, the portable electronic device may determine whether the object displayed in the display 170 is displayed according to whether the user taps the object as shown in FIGS. 4D and/or 5D. As an example, the tap indicates a series of successive touch releases of the user after the touch input is detected.

If the object is not selected during a reference time, the portable electronic device finishes this process.

In contrast, when at least one object is selected, the portable electronic device displays an object control menu in step 215. For example, when at least one object is selected, the portable electronic device displays the control menu 405 or 505 as shown in FIGS. 4D and/or 5D. In so doing, the portable electronic device displays the selection of each object. When at least object is selected, the portable electronic device proceeds to step 217.

In step 217, the portable electronic device determines whether the control menu is selected. For example, the portable electronic device determines whether any one of functions corresponding to a “Delete” function, a “Move” function, a “Cancel” function, and the like of the control menu 405 or 505 is selected as shown in FIGS. 4D and/or 5D.

If the control menu is not selected within a predefined time period, the process returns to step 217 at which the portable electronic device polls for selection of the control menu.

When the control menu is selected, the portable electronic device processes the at least one selected object according to a type of the selected control menu in step 219. For example, when the function corresponding to a “Delete” function of the control menu is selected in FIG. 4D, the portable electronic device deletes the first and fourth objects selected (e.g., FIG. 4D illustrates Object 1 and Object 4 as being selected) in step 213. For example, when the function corresponding to a “Move” function of the control menu is selected in FIG. 4D, the portable electronic device moves locations of the first and fourth objects selected in step 213. For example, when the function corresponding to a “Cancel” function of the control menu is selected in FIG. 4D, the portable electronic device releases the selection of the first and fourth objects selected in step 213.

Next, the portable electronic device finishes this process.

According to an exemplary embodiment of the present invention, the portable electronic device displays the control menu in the display 170 when the object is selected.

Alternatively, according to another exemplary embodiment of the present invention, the portable electronic device may display the control menu in the display 170 even when the object is not selected.

FIG. 3 is a flowchart of a method for changing an object size in a portable electronic device according to another exemplary embodiment of the present invention.

Referring to FIGS. 3, 4A to 4D, and 5A to 5D, the portable electronic device determines whether to display at least one object in the display 170 in step 301. For example, the portable electronic device determines whether the user executes the application program to display the thumbnail image. As an example, the portable electronic device determines whether the user executes the standby mode to display the object of the application program installed in the portable electronic device.

If the portable electronic device determines that at least one object is not to be displayed in step 301, the portable electronic device ends the process.

In contrast, if the portable electronic device determines that at least one object is to be displayed in step 301, the portable electronic device proceeds to step 303.

To display the object, the portable electronic device displays at least one object in the display 170 according to an i-th arrangement in step 303. For example, the portable electronic device displays at least one object in the display 170 according to the basic object display arrangement as shown in FIG. 4A. As an example, the portable electronic device may display at least one object in the display 170 according to the last arrangement used by the previous object display algorithm for the object display. Specifically, when the previous object display algorithm displays objects in the 3×2 arrangement, which is the third arrangement, as shown in FIG. 4C, the portable electronic device displays at least one object in the display 170 according to the 3×2 arrangement as shown in FIG. 5A.

In step 305, the portable electronic device determines whether a zoom-in event occurs. For example, the portable electronic device determines whether the zoom-in icon 401 is selected in an object display screen as shown in FIG. 4A. As an example, the portable electronic device can determine whether the zoom-in event generates based on the touch information. For example, the portable electronic device may determine whether the zoom-in event is generated based on the user's gesture.

When the zoom-in event occurs, the portable electronic device determines whether an arrangement index of the object display is smaller than a maximum number of the arrangement in step 307. As an example, the maximum number of the arrangement may be predefined by a user of the portable electronic device.

When the arrangement index of the object display in step 303 is greater than or equal to the maximum number of the arrangement, the portable electronic device determines that the objects cannot be enlarged any further. In this case, the portable electronic device finishes this process. For example, the portable electronic device may determine whether the object is selected in step 317.

When the arrangement index of the object display in step 303 is smaller than the maximum number of the arrangement, the portable electronic device determines that the objects can be further enlarged. Hence, the portable electronic device increases the arrangement index by one level in step 309.

Next, the portable electronic device displays at least one object in the display 170 according to the i-th arrangement in step 303. For example, when the zoom-in event occurs in the object display screen of the 5×4 arrangement which is the first arrangement of FIG. 4A, the portable electronic device changes the object display arrangement to the4×3 arrangement being the second arrangement and enlarges the object size as shown in FIG. 4B. For example, using the 5×4 arrangement, the portable electronic device can display 20 objects in the display 170. Using the 4×3 arrangement, the portable electronic device can display 12 objects in the display 170. Hence, the portable electronic device can change the object display arrangement to the 4×3 arrangement and enlarge the object size. For example, when the zoom-in event takes place in the object display screen of the4×3 arrangement which is the second arrangement of FIG. 4B, the portable electronic device changes the object display arrangement to the 3×2 arrangement being the third arrangement and enlarges the object size as shown in FIG. 4C. For example, using the4×3 arrangement, the portable electronic device can display 12 objects in the display 170. Using the 3×2 arrangement, the portable electronic device can display 6 objects in the display 170. Hence, the portable electronic device can change the object display arrangement to the 3×2 arrangement and enlarge the object size.

In contrast, when no zoom-in event occurs in step 305, the portable electronic device determines whether a zoom-out event occurs in step 311. For example, the portable electronic device determines whether the zoom-out icon 403 or 503 is selected in the object display screen as shown in FIG. 5A. For example, the portable electronic device can determine whether the zoom-out event is generated based on the touch information. For example, the portable electronic device may determine whether the zoom-out event takes occurs based on the user's gesture.

When the zoom-out event occurs, the portable electronic device determines whether the arrangement index of the object display is smaller than a minimum number of the arrangement in step 313.

When the arrangement index of the object display in step 303 is greater than or equal to the minimum number of the arrangement, the portable electronic device determines that the objects cannot be reduced any more. In this case, the portable electronic device finishes this process. For example, the portable electronic device may determine whether the object is selected in step 317.

When the arrangement index of the object display in step 303 is smaller than the minimum number of the arrangement, the portable electronic device determines that the objects can be further reduced. Accordingly, the process proceeds to step 315. The portable electronic device decreases the arrangement index by one level in step 315.

Next, the portable electronic device reduces and displays at least one object in the display 170 according to the i-th arrangement in step 303. For example, when the zoom-out event occurs in the object display screen of the 3×2 arrangement which is the third arrangement of FIG. 5A, the portable electronic device changes the object display arrangement to the4×3 arrangement being the second arrangement and reduces the object size as shown in FIG. 5B. For example, when the zoom-out event occurs in the object display screen of the4×3 arrangement which is the second arrangement of FIG. 5B, the portable electronic device changes the object display arrangement to the 5×4 arrangement being the first arrangement and reduces the object size as shown in FIG. 5C.

In addition, after displaying the object in step 303, the portable electronic device determines whether the object displayed in the display 170 is selected in step 317. For example, the portable electronic device determines whether the user taps the object as shown in FIGS. 4D and/or 5D.

When the object is not selected during the reference time, the portable electronic device finishes this process.

If the portable electronic device determines that a zoom-out event does not occur in step 311, the portable electronic device determines whether at least one object is selected. When at least one object is selected, the portable electronic device displays the object control menu in step 319. For example, when at least one object is selected, the portable electronic device displays the control menu 405 or 505 as shown in FIGS. 4D and/or 5D. In so doing, the portable electronic device displays the selection of each object.

In step 321, the portable electronic device determines whether the control menu is selected. For example, the portable electronic device determines whether any one of a function of a “Delete” function, a “Move” function, and a “Cancel” function of the control menu 405 or 505 is selected as shown in FIGS. 4D and/or 5D.

If the portable electronic device determines that the control menu is selected, the portable electronic device proceeds to step 323. In step 323, the portable electronic device processes the at least one object selected in step 317, according to the type of the selected control menu. As an example, when the “Delete” function of the control menu is selected in FIG. 4D, the portable electronic device deletes the first and fourth objects selected in step 317. As another example, when the “Move” function of the control menu is selected in FIG. 4D, the portable electronic device moves the locations of the first and fourth objects selected in step 317. As yet another example, when the “Cancel” function of the control menu is selected in FIG. 4D, the portable electronic device releases the selection of the first and fourth objects selected in step 317.

Next, the portable electronic device finishes this process.

According to an exemplary embodiment of the present invention, the portable electronic device displays the control menu in the display 170 when the object is selected.

Alternatively, according to another exemplary embodiment of the present invention, the portable electronic device may display the control menu in the display 170 even when the object is not selected.

As such, according to an exemplary embodiment of the present invention, the portable electronic device enlarges or reduces the object size by changing the object display arrangement as shown in FIG. 2 or 3.

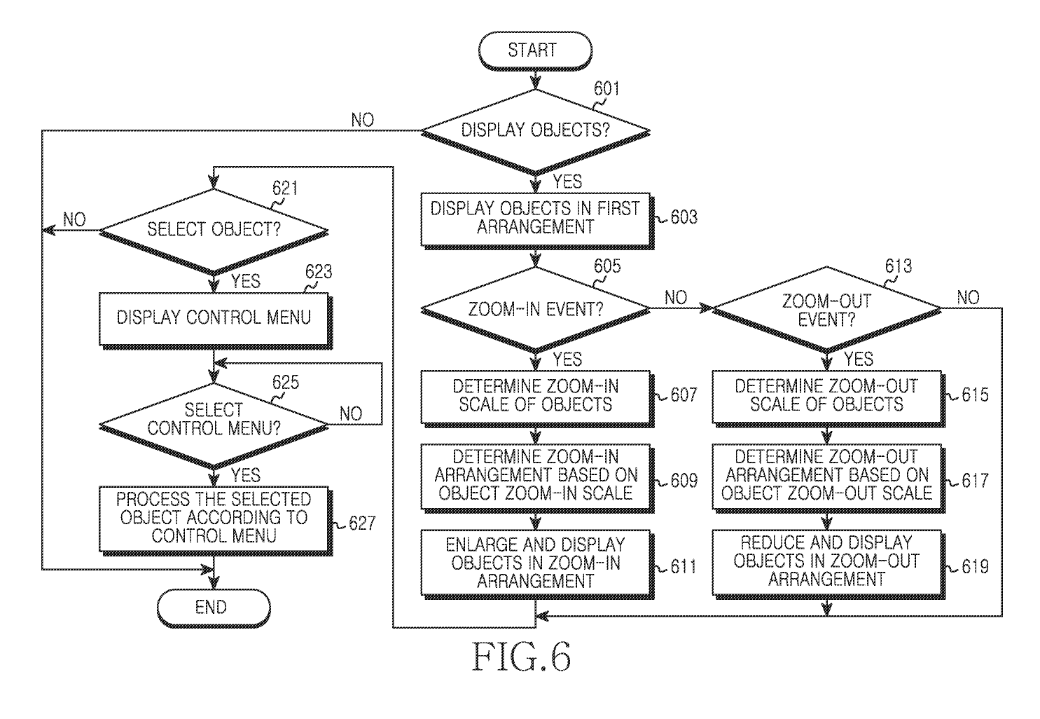

Alternatively, according to another exemplary embodiment of the present invention, the portable electronic device may change the object display arrangement according to a scale of the object as shown in FIG. 6.

FIG. 6 is a flowchart of a method for changing an object size in a portable electronic device according to yet another exemplary embodiment of the present invention. FIGS. 7A to 7C are diagrams of a screen configuration for changing an object size in a portable electronic device according to yet another exemplary embodiment of the present invention. FIGS. 8A to 8C are diagrams of a screen configuration for changing an object size in a portable electronic device according to still another exemplary embodiment of the present invention.

Referring to FIGS. 6, 7A-7C, and 8A-8C, the portable electronic device determines whether to display at least one object in the display 170 in step 601. For example, the portable electronic device determines whether the user executes the application program to display the thumbnail image. For example, the portable electronic device determines whether the user executes the standby mode to display the object of the application program installed in the portable electronic device.

If the portable electronic device determines that at least one object is not to be displayed in step 601, the portable electronic device ends the process.

In contrast, if the portable electronic device determines that at least one object is to be displayed in step 601, the portable electronic device proceeds to step 603. To display the object, the portable electronic device displays at least one object in the display 170 according to the first arrangement in step 603. For example, the portable electronic device displays at least one object in the display 170 according to the basic object display arrangement as shown in FIG. 7A. For example, the portable electronic device may display at least one object in the display 170 according to the last arrangement used by the previous object display algorithm for the object display. Specifically, when the previous object display algorithm displays objects in the 3×2 arrangement as shown in FIG. 7B, the portable electronic device may display at least one object in the display 170 according to the 3×2 arrangement as shown in FIG. 8A.

In step 605, the portable electronic device determines whether a zoom-in event is generated. For example, the portable electronic device determines whether a multi-touch generates the zoom-in event as shown in FIG. 7A. For example, the portable electronic device can determine whether the zoom-in icon is selected. For example, the portable electronic device may determine whether the zoom-in event occurs based on the user's gesture.

When the zoom-in event occurs, the portable electronic device determines the zoom-in scale of the object according to the zoom-in event in step 607. As an example, the portable electronic device determines the zoom-in scale of the object based at least in part on a distance change between multi-touch points in FIG. 7A. For example, the portable electronic device can obtain a reference zoom-in scale.

In step 609, the portable electronic device determines the zoom-in arrangement based at least in part on the object zoom-in scale and a size of the display 170. For example, the portable electronic device determines the zoom-in arrangement by comparing width and length of the object to enlarge with width and length of the display 170.

In step 611, the portable electronic device enlarges and displays the object according to the zoom-in arrangement. For example, when the zoom-in event occurs in the object display screen of the 5×4 arrangement of FIG. 7A, the portable electronic device enlarges and displays the object in the 3×2 zoom-in arrangement as shown in FIG. 7B.

In contrast, when the zoom-in event does not occur in step 605, the portable electronic device determines whether the zoom-out event occurs in step 613. For example, the portable electronic device determines whether the multi-touch generates the zoom-out event as shown in FIG. 8A. For example, the portable electronic device can determine whether the zoom-out icon is selected. For example, the portable electronic device may determine whether the zoom-out event takes place based on the user's gesture.

When the zoom-out event occurs, the portable electronic device determines the zoom-out scale of the object according to the zoom-out event in step 615. For example, the portable electronic device determines the zoom-out scale of the zoom-out object based at least in part on a distance change between multi-touch points in FIG. 8A. For example, the portable electronic device can obtain a reference zoom-out scale.

In step 617, the portable electronic device determines the zoom-out arrangement based at least in part on the object zoom-out scale and the size of the display 170. For example, the portable electronic device determines the zoom-out arrangement by comparing a width and length of the object to reduce with the width and the length of the display 170.

In step 619, the portable electronic device reduces and displays the object according to the zoom-out arrangement. For example, when the zoom-out event occurs in the object display screen of the 3×2 arrangement of FIG. 8A, the portable electronic device reduces and displays the objects in the 5×4 zoom-out arrangement as shown in FIG. 8B.

In addition, after displaying the object in steps 611, and 619, or after determining that a zoom-out event has not occurred in step 613, the portable electronic device determines whether the object displayed in the display 170 is selected in step 621. For example, the portable electronic device determines whether the user taps the object as shown in FIG. 7C or 8C (e.g., FIG. 7C illustrates Object 1 and Object 4 as being selected, and FIG. 8C illustrates Object 2, Object 5, and Object 11 as being selected).

When the object is not selected during the reference time, the portable electronic device finishes this process.

When at least one object is selected, the portable electronic device displays the object control menu in step 623. For example, when at least one object is selected, the portable electronic device displays the control menu 700 or 800 as shown in FIG. 7C or 8C. In so doing, the portable electronic device displays the selection of each object (e.g., FIG. 7C illustrates Object 1 and Object 4 as being selected; and FIG. 8C illustrates Object 2, Object 5, and Object 11 as being selected).

In step 625, the portable electronic device determines whether the control menu is selected. For example, the portable electronic device determines whether any one of a “Delete”, a “Move”, and a “Cancel” function of the control menu 700 or 800 is selected as shown in FIG. 7C or 8C.

In step 627, When the control menu is selected, the portable electronic device equally processes the at least one object selected in step 623, according to the type of the selected function of control menu. As an example, when the “Delete” function of the control menu is selected in FIG. 7C, the portable electronic device deletes the first and fourth objects selected in step 621. As another example, when the “Move” function of the control menu is selected in FIG. 7C, the portable electronic device moves the locations of the first and fourth objects selected in step 621. As yet another example, when the “Cancel” menu is selected in FIG. 7C, the portable electronic device releases the selection of the first and fourth objects selected in step 621.

Next, the portable electronic device finishes this process.

According to an exemplary embodiment, the portable electronic device displays the control menu in the display 170 when the object is selected.

Alternatively, according to another exemplary embodiment of the present invention, the portable electronic device may display the control menu in the display 170 even when the object is not selected.

As such, the portable electronic device changes the object size and arrangement displayed in the display 170 according to the zoom-in event or the zoom-out event. According to the zoom-in event or the zoom-out event, the portable electronic device may change the object arrangement by altering only the size of some of the objects displayed in the display 170.

As set forth above, because the portable electronic device changes the display arrangement of the objects according to the object scale, the user can accurately identify the objects displayed in the screen.

Further, the portable electronic device changes and displays the size and the display arrangement of the objects so that the user can accurately identify the objects. Therefore, the user can easily select and manage the objects.

It will be appreciated that exemplary embodiments of the present invention according to the claims and description in the specification can be realized in the form of hardware, software or a combination of hardware and software. Any such software may be stored in a non-transient computer readable storage medium. The computer readable storage medium stores one or more programs (software modules), the one or more programs comprising instructions, which when executed by one or more processors in an electronic device, cause the electronic device to perform a method of the present invention. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. St.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for displaying an object in an electronic device, the method comprising:
displaying at least one object according to a first arrangement;
when an object size change event occurs, changing a size of the at least one object according to a second arrangement; and
displaying the at least one object having the changed size.

2. The method of claim 1, wherein the at least one object comprises at least one of an application program icon, a widget, and a thumbnail image.

3. The method of claim 1, wherein the first arrangement comprises any one of a reference arrangement and a previous arrangement used to display the at least one object.

4. The method of claim 1, wherein the changing of the size of the at least one object comprises:
when a zoom-in event occurs, enlarging the size of the at least one object according to the second arrangement.

5. The method of claim 4, further comprising:
when the zoom-in event occurs, determining whether to enlarge the size of the at least one object by considering the first arrangement,
wherein, when determining whether to enlarge the size of the at least one object, the size of the at least one object is enlarged according to the second arrangement and the at least one object having the enlarged size is displayed.

6. The method of claim 1, wherein the changing of the size of the at least one object comprises:
when a zoom-out event occurs, reducing the size of the at least one object according to the second arrangement.

7. The method of claim 6, further comprising:
when the zoom-out event occurs, determining whether to reduce the size of the at least one object by considering the first arrangement,
wherein, when determining whether to reduce the size of the at least one object, the size of the at least one object is reduced according to the second arrangement and the at least one object having the reduced size is displayed.

8. The method of claim 1, wherein the changing of the size of the at least one object comprises:
when an object size change event occurs, determining a scale of the at least one object;
determining the second arrangement by considering the scale of the at least one object and a display area size; and
enlarging the size of the at least one object by changing an arrangement of the at least one object according to the second arrangement and displaying the at least one object having the enlarged size.

9. The method of claim 8, wherein the determining of the scale of the at least one object comprises:
when detecting a multi-touch, determining the scale of the at least one object by considering an interval change of multi-touch points.

10. The method of claim 1, further comprising:
after changing the size of the at least one object, displaying at least one control menu when at least one of the at least one object is selected; and
when one of the displayed control menu is selected, processing the at least one selected object according to the selected control menu.

11. An apparatus of an electronic device, the apparatus comprising:
a display;
at least one processor;
a storage; and
at least one program stored in the storage and configured for execution by the at least one processor,
wherein the program comprises:
instructions for displaying at least one object in the display according to a first arrangement, for changing a size of the at least one object according to a second arrangement when an object size change event occurs, and for displaying the at least one object having the changed size in the display.

12. The apparatus of claim 11, wherein the at least one object comprises at least one of an application program icon, a widget, and a thumbnail image.

13. The apparatus of claim 11, wherein the first arrangement comprises any one of a reference arrangement and a previous arrangement used to display the at least one object.

14. The apparatus of claim 11, wherein, when a zoom-in event occurs, the program enlarges the size of the at least one object according to the second arrangement and displays the at least one object having the enlarged size.

15. The apparatus of claim 14, wherein, when the zoom-in event occurs, the program determines whether to enlarge the size of the at least one object by considering the first arrangement, and
when determining whether to enlarge the size of the at least one object, the program enlarges the size of the at least one object according to the second arrangement and the at least one object having the enlarged size is displayed.

16. The apparatus of claim 11, wherein, when a zoom-out event occurs, the program reduces the size of the at least one object according to the second arrangement and displays the at least one object having the reduced size.

17. The apparatus of claim 16, wherein, when the zoom-out event occurs, the program determines whether to reduce the size of the at least one object by considering the first arrangement, and
when determining whether to reduce the size of the at least one object, the program reduces the size of the at least one object according to the second arrangement and displays the at least one object having the reduced size.

18. The apparatus of claim 11, wherein, when an object size change event occurs, the program determines a scale of the at least one object, determines the second arrangement by considering the object scale and a display area size, and enlarges the size of the at least one object and displays the at least one object having the enlarged size by changing an arrangement of the at least one object according to the second arrangement.

19. The apparatus of claim 18, wherein, when detecting a multi-touch, the program determines the scale of the at least one object by considering an interval change of multi-touch points.

20. The apparatus of claim 11, wherein, after changing the size of the at least one object, the program displays at least one control menu when at least one of the at least one object is selected, and
when one of the displayed control menu is selected, the program processes the at least one selected object according to the selected control menu.
